(19) United States
(12) Patent Application Publication
(10) Pub. No.: US 2007/0268241 A1
(43) Pub. Date: Nov. 22, 2007

(54) Display Device

(76) Inventors: HIROYUKI NITTA, Fujisawa (JP); Hideo Sato, Hitachi (JP); Yasuyuki Kudo, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/747,975

(22) Filed: May 14, 2007

(30) Foreign Application Priority Data
May 16, 2006 (JP) 2006-136377

(51) Int. Cl. G09G 3/36

(52) U.S. Cl. 345/102

(57) ABSTRACT

An ambient light sensor 10 and a backlight sensor 9 are located on the liquid crystal panel 6 adjacently to each other, for correcting a variation of an output characteristic of the ambient light sensor 10. This location keeps the manufacturing variation of each liquid crystal panel 6 even in these two light sensors 9 and 10. A degree of variation of an output of the backlight sensor 9 for sensing a ray of backlight from a backlight module relative to a predetermined reference value is detected. Based on the detected result, the output of the ambient light sensor 10 is corrected. This operation makes it possible to improve sensing accuracy of the ambient light sensor 10 and keep the light modulation even in each liquid crystal panel provided with the ambient light sensor 10.

### INCORPORATION BY REFERENCE

The present application claims priority from Japanese application JP2006-136377 filed on May 16, 2006, the content of which is hereby incorporated by reference into this application.

### BACKGROUND OF THE INVENTION

The present invention relates to a display device which provides a capability of modulating a luminance of a backlight ray to be radiated to a rear surface of a display panel according to the ambient illuminance.

A liquid crystal display device, in particular, a liquid crystal display device used in a portable instrument, is equipped with a capability of modulating a luminance of a backlight ray according to the ambient illuminance for the purpose of improving visibility and image quality of the display screen whenever the display device may be located indoors or outdoors.

For example, when the display device is located in an environment with high ambient light such as an outdoor place in clear weather and daytime, the luminance of a backlight ray is controlled to be larger for improving the visibility of the display screen. On the other hand, when the display device is located in an environment with low ambient light such as an indoor place or an outdoor place at night, the luminance of a backlight ray is controlled to be smaller for improving the visibility of the display device and reducing the power consumption thereof.

For controlling the illumination of the liquid crystal display device so that the luminance of the backlight ray may be kept optimal, it is necessary to provide a light sensor that senses an illuminance of ambient light in the display device. The light sensor is required to have a highly sensing capability of accurately sensing an illuminance of ambient light so that the luminance of the backlight ray in the display device may be controlled according to the sensed illuminance of the ambient light.

As a technology of mounting the light sensor in the liquid crystal display device, a light modulating technology with a built-in light sensor, in which a light sensor is integrally formed with the liquid crystal display panel, has been described in the Official Gazette of JP-A-2002-23658.

In the technology disclosed in JP-A-2002-23658, for modulating light stepwise, a plurality of light sensing means having their filters with respective light transmittances and for sensing a light quality entered from the outside through those filters are provided for comparing the light qualities of those light sensing means with their corresponding predetermined reference light quantities and controlling illumination of each luminous element whose light is to be modulated. This composition offers a light modulating system that has a capability of modulating light in small circuit scale in the case of modulating light stepwise.

### SUMMARY OF THE INVENTION

As to the ambient light sensor built in the liquid crystal display panel, the manufacturing variation or the other factors of the liquid crystal panel cause the characteristic of an output intensity to an input intensity to be variable in each liquid crystal panel. Hence, the capability of modulating light is required to be corrected in each liquid crystal panel, which leads to a factor of enhancing the manufacturing cost. The technology disclosed in JP-A-2002-23658 realizes the stepwise light modulation but does not consider reduction of a variation of each liquid crystal panel caused by the manufacturing variation of each ambient light sensor.

That is, the output characteristic of the ambient light sensor built in the liquid crystal display panel has been variable in each liquid crystal panel because of the manufacturing variation of the liquid crystal panel. Hence, the light modulation of the liquid crystal panel according to the ambient light has been variable in each liquid crystal panel.

It is an object of the present invention to provide a display device having incorporated an ambient light sensor in a display panel which device is designed to reduce a manufacturing variation of each display panel, for improving output accuracy of the ambient light sensor.

In order to correct a variation of an output characteristic appearing in each ambient light sensor (ambient light sensing means), the ambient light sensor is installed adjacent to a backlight light sensor (backlight sensing means) for sensing a ray of backlight. This adjacent installation of these two light sensors makes the manufacturing variation even in each display panel. The operation is executed to detect a degree of variation of an output of the backlight sensor relative to a predetermined reference value and to correct the output of the ambient light sensor based on the detected variation. This operation makes it possible to improve the detecting accuracy of the ambient light sensor so that the light modulation of the display panel through the ambient light sensor may be implemented evenly in each display panel.

The variation of each ambient light sensor may be corrected by modulating a quantity of a backlight ray. This makes it possible to reduce the manufacturing variation of each display panel and to realize the highly accurate light modulation.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a liquid crystal display device according to an embodiment of the present invention;

FIG. 2 is a sectional view showing a part of a pair of light sensors;

FIG. 3 is a block diagram showing a sensor output control circuit;

FIG. 4 is a graph showing relation between an incident light intensity and an output intensity of backlight sensor pair;

FIG. 5 is a block diagram showing a light modulation circuit;

FIG. 6 is a graph showing relation between an illuminance of received light and a backlight luminance of ambient light sensors;

FIG. 7 is a sectional diagram showing a part of a light sensor pair;

FIG. 8 is a sectional diagram showing a part of a light sensor pair;

FIG. 9 is a sectional diagram showing a part of a light sensor pair;

FIG. 10 is a diagram showing a liquid crystal display device according to another embodiment of the present invention;

FIG. 11 is a block diagram showing a liquid crystal display device according to another embodiment of the present invention;

FIG. 12 is a sectional diagram showing a part of a light sensor pair;

FIG. 13 is a block diagram showing a sensor output control circuit;

FIGS. 14A and 14B are graphs showing relation between an incident light intensity and an output intensity of light sensors; and

FIG. 15 is a sectional diagram showing a part of a light sensor pair.

### DESCRIPTION OF THE EMBODIMENTS

Hereafter, the embodiments of the present invention will be described with reference to the appended drawings.

### First Embodiment

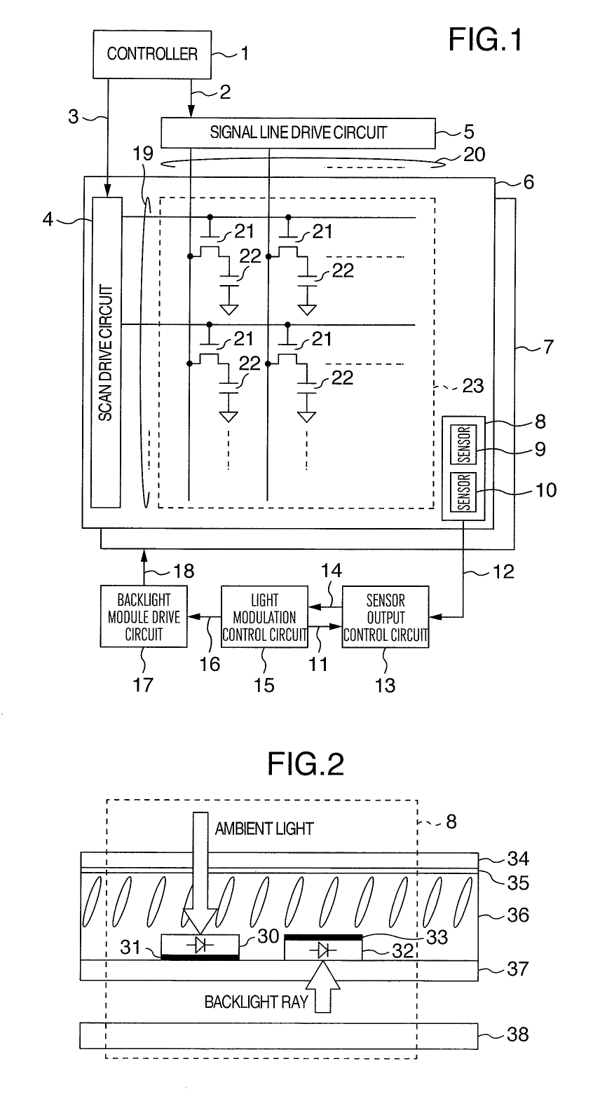

The first embodiment of the present invention will be described with reference to FIGS. 1 to 6.

FIG. 1 is a block diagram showing a liquid crystal display device according to the present invention. A numeral 1 denotes a controller, a numeral 2 denotes display data, a numeral 3 denotes a control signal, a numeral 4 denotes a scan line drive circuit, a numeral 5 denotes a signal line drive circuit, a numeral 6 denotes a liquid crystal panel, a numeral 7 denotes a backlight module, a numeral 8 denotes a light sensor pair formed in the liquid crystal panel 6, a numeral 9 denotes a backlight sensing means (backlight sensor) of the light sensor pair 8, a numeral 10 denotes an ambient light sensing means (ambient light sensor) of the light sensor pair 8, a numeral 11 denotes light modulation setting data (to be used for setting a light modulation level), a numeral 12 denotes a light sensor output, a numeral 13 denotes a sensor output control circuit, a numeral 14 denotes a corrected output, a numeral 15 denotes a light modulation control means (light modulation control circuit), a numeral 16 denotes a light modulation control signal, a numeral 17 denotes a backlight module drive circuit, a numeral 18 denotes a backlight drive signal, a numeral 19 denotes a scan line, a numeral 20 denotes a signal line, a numeral 21 denotes a TFT (Thin Film Transistor) element, a numeral 22 denotes a liquid crystal element, and a numeral 23 denotes a pixel composed of the TFT element 21 and the liquid crystal element.

FIG. 2 is a sectional diagram showing a part of the light sensor pair 8 shown in FIG. 1. In FIG. 2, a numeral 30 denotes an ambient light sensor, a numeral 31 denotes a backlight shading means (backlight shading film), a numeral 32 denotes a backlight sensor, a numeral 33 denotes an ambient light shading means (ambient light shading film), a numeral 34 denotes an upper glass substrate located on the display screen side, a numeral 35 denotes a color filter, a numeral 36 denotes a liquid crystal layer, a numeral 37 denotes a lower glass substrate, and a numeral 38 denotes a backlight unit. The ambient light sensor 30 and the backlight sensor 32 are incorporated in the liquid crystal panel 6 in the process of manufacturing the liquid crystal panel 6. For the ambient light sensor 30 and the backlight sensor 32 may be used a sensor having the same performance and function.

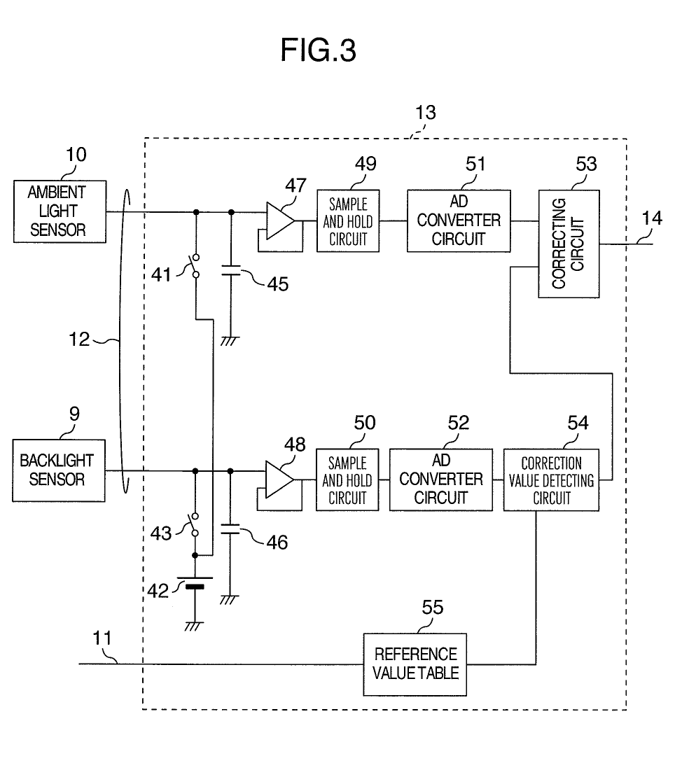

FIG. 3 is a block diagram showing the sensor output control circuit 13 shown in FIG. 1. In FIG. 3, a numeral 41 denotes a precharge switch for the ambient light sensor, a numeral 43 denotes a precharge switch for the backlight sensor, a numeral 42 denotes a precharge power supply, a numeral 45 or 46 denotes a sensor output capacitance, a numeral 47 or 48 denotes a buffer circuit, a numeral 49 or 50 denotes a sample and hold circuit, a numeral 51 or 52 denotes an AD converter circuit. Further, a denotes 54 denotes a correction value detecting means (correction value detecting circuit) for detecting a correction value of the backlight sensor 9, a numeral 55 denotes a reference value table, and a numeral 53 denotes a correcting means (correcting circuit) for correcting an output of the ambient light sensor 10 based on the detected correction value.

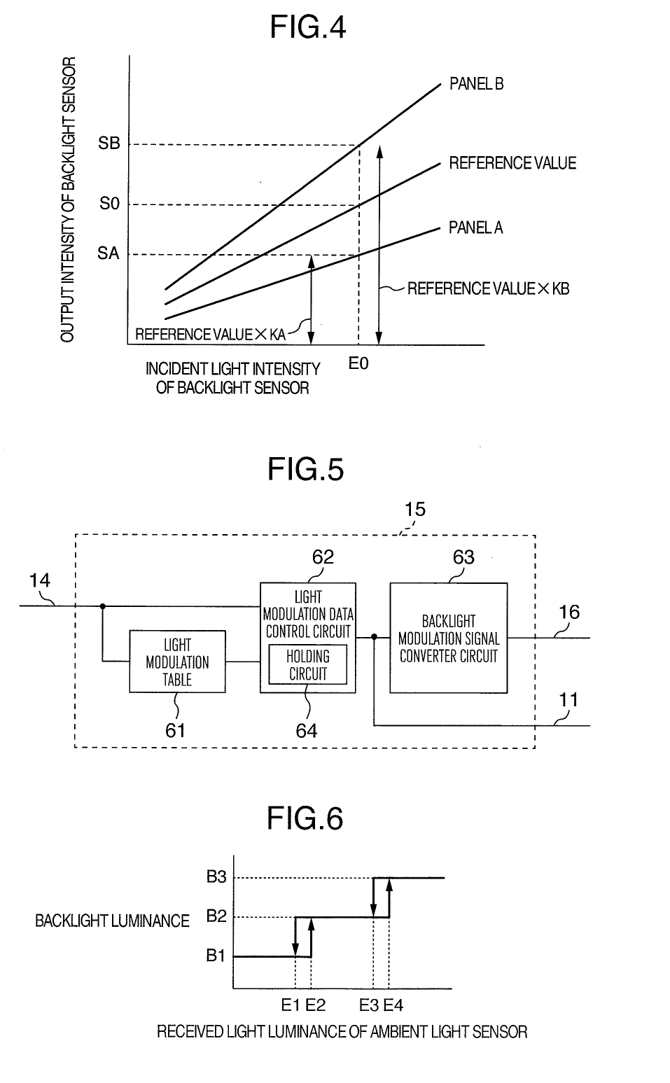

FIG. 4 shows relation between an incident light intensity and an output intensity of the backlight sensor 9 or 32 shown in FIG. 1 or 2.

FIG. 5 is a block diagram showing the light modulation control circuit 15 shown in FIG. 1. In FIG. 5, a numeral 61 denotes a light modulation table, a numeral 62 denotes a light modulation data control circuit, a numeral 63 denotes a backlight modulation signal converter circuit, and a numeral 64 denotes a holding circuit.

FIG. 6 shows relation between a received light illuminance and a backlight luminance of the ambient light sensor 10 or 30 shown in FIG. 1 or 2.

In turn, the description will be oriented to the operation of the liquid crystal display device according to the first embodiment of the invention. As shown in FIG. 1, the pixel portion 23 of the liquid crystal panel 6 is operated normally. That is, the controller 1 is supplied with a display signal from a system apparatus (not shown) and generates the display data 2 correspondingly with the signal line drive circuit 5 and the control signal 3 correspondingly with the scan line drive circuit 4.

The signal line drive circuit 5 outputs a liquid crystal drive voltage of one line, the voltage corresponding with the display data 2 transferred from the controller 1, to the signal 20 at a time. The scan line drive circuit 4 operates to output a selection voltage for switching on the TFT elements 21 composing one scan line in sequence from the head line of the display and to write a liquid crystal drive voltage outputted from the signal line drive circuit 5 in the liquid crystal elements 22. By sequentially executing this operation from the head line of the liquid crystal panel 6 to the last line in each frame, the data display of one frame is completed. In the next frame, the selection from the head line is executed similarly, for realizing the data display of the next frame.

In FIG. 1, the signal line drive circuit 5 is separate from the liquid crystal panel 6 and the scan line drive circuit 4 is incorporated in the liquid crystal panel 6. Without being limited to this arrangement, the scan drive circuit 4 may be connected outside the liquid crystal panel 6. Instead, the controller 1 and the signal line drive circuit 5 may be implemented as a one-chip LSI. Further, the controller 1, the scan line drive circuit 4 and the signal line drive circuit may be implemented as a one-chip LSI.

As shown in FIG. 1, the light sensor pair 8 located in the liquid crystal panel 6 includes the ambient light sensor 30 and the backlight sensor 32, each of which is composed of a photoelectric converting thin film transistor, installed adjacent to each other. The light sensor pair 8 is located on the lower glass substrate 37 of the normally paired glass substrates 34 and 37, that is, the glass substrate on which the TFT elements are formed.

In FIG. 2, the ray of backlight (often referred simply to as backlight) radiated from the backlight unit 38 is controlled through the effect of an electric field being applied onto the liquid crystal layer 36. In the normal longitudinal electric field drive liquid crystal panel, the common electrodes and the signal electrodes for pixels are provided on the upper glass substrate 34 and the lower glass substrate 37 so that the electric field may be applied onto the liquid crystal panel. On the other hand, in the horizontal electric field drive liquid crystal panel, the common electrodes and the signal electrodes for pixels are provided on the lower glass substrate 37 so that the electric field may be applied onto the liquid crystal panel. The control of the backlight according to the applied electric field makes it possible to display an image on the liquid crystal panel.

In turn, the description will be oriented to the light modulation control of the liquid crystal display device according to the first embodiment of the invention. As shown in FIG. 2, the ambient light sensor 30 senses a light quantity of the ambient light applied from the upper glass substrate 34. The light applied from the backlight unit 38 is cut off by the backlight shading film 31 so that the influence on the ambient light sensor 30 by the backlight may be eliminated.

Further, the backlight sensor 32 senses a light quantity of the backlight applied from the lower glass substrate 37. The light applied from the upper glass substrate 34 is cut off by the ambient light shading film 33 so that the influence on the backlight sensor 32 by the ambient light may be eliminated. Hence, the ambient light sensor 30 senses and outputs a light quantity of the ambient light and the backlight sensor 32 senses and outputs a backlight quantity at a time.

The output of the light sensor pair 8 shown in FIG. 1 made up of the ambient light sensor 30 and the backlight sensor 32 is applied as the light sensor output 12 to the sensor output control circuit 13.

The operation of this sensor output control circuit 13 will be described with reference to FIG. 3. The output of the ambient light sensor 10 is connected with the sensor output capacitance 45 and also connected with the precharge power supply 42 through the precharge switch 41. Further, the output of the backlight sensor 9 is connected with the sensor output capacitance 46 and also connected with the precharge power supply 42 through the precharge switch 43.

The precharge power supply 42 is a power supply for precharging a voltage to the sensor output capacitances 45 and 46. The output voltage of the power supply 42 may be a predetermined constant voltage. Instead, the output voltage may be modulated according to the backlight quantity or the like.

At the outset of the sensing operation of the light sensor 9 or 10, the sensor output capacitance 46 or 45 is set to a predetermined precharge voltage by turning on the precharge switch 41 or 43. During the sensing period of the light sensor 9 or 10, the precharge switch 41 or 43 is turned off, so that the charges stored in the sensor output capacitance 46 or 45 may be discharged through the light sensor 9 or 10 whose current amount is varied according to the received light intensity. As a result, the charges corresponding with the received light intensity are left in the sensor output capacitance 46 or 45.

The buffer circuit 47 or 48 operates to buffer the voltage charged in the sensor output capacitance 45 or 46 and to output the voltage to the sample and hold circuit 49 or 50 located at the next stage. A certain length of time later than the initialization of the precharge voltage, the sample and hold circuit 49 or 50 performs the sample and hold operation for holding the voltage of the sensor output capacitance 45 or 46. The voltage held in the sample and hold circuit 49 or 50 is converted from an analog voltage to digital data through the effect of the AD converter circuit 51 or 52. That is, the output corresponding with a light quantity sensed by the ambient light sensor 10 or the backlight sensor 9 is outputted as the digital data from the AD converter circuit 51 or 52.

In turn, the description will be oriented to the operations of the correction value detecting circuit 54, the reference value table 55 and the correcting circuit 53.

The correction value detecting circuit 54 calculates a degree of variation of the output intensity of the backlight sensor 9 relative to the reference value, based on the relation between the incident light intensity of the backlight sensor 9 shown in FIG. 4 and the output intensity thereof.

The current light modulation is carried out by referring to the light modulation setting data 11. The reference value corresponding with the light modulation setting data 11 is read out of the reference value table 55. The backlight luminance reference value in this case is set to E0 as shown in FIG. 4 and the reference output value of the backlight sensor 9 in this case is set to S0.

For example, letting SA be the output intensity of the backlight sensor 9 of the panel A shown in FIG. 4 against the backlight luminance reference value E0, the output intensity SA of the backlight sensor 9 of the panel A is variable by a coefficient KA relative to the reference value. Further, letting SB be the output intensity of the backlight sensor 9 of the panel B against the backlight luminance reference value E0, the output intensity SB of the backlight sensor 9 of the panel B is variable by a coefficient KB relative to the reference value. As such, the correction value detecting circuit 54 detects the characteristic of the backlight sensor 9 for each liquid crystal panel based on the backlight luminance reference value E0.

Next, the correcting circuit 53 corrects the output of the ambient light sensor 10 based on the detected result of the backlight sensor 9 and then outputs it as the corrected output 14. For example, for the panel A shown in FIG. 4, with respect to the incident light intensity, the output intensity is KA times more variable than the reference value. It means that the output of the ambient light sensor 10 is KA times more shifted if the output is uses as it is. Hence, the correcting circuit 53 corrects the output of the ambient light sensor 10 by a factor of 1/KA. This correction results in making the corrected output 14 more accurate. Likewise, for the panel B, with respect to the incident light intensity, the output intensity is KB times more variable than the reference value. It means that the output of the ambient light sensor 10 is KB times more shifted if the output is used as it is. Hence, the correcting circuit 53 corrects the output of the ambient light sensor 10 by a factor of 1/KB. This correction also results in making the corrected output 14 more accurate.

That is, the adjacent installation of the backlight sensor 9 and the ambient light sensor 10 makes it possible to keep the manufacturing variations like the process variation even in these two light sensors. Hence, for each panel, by detecting the correction value about the degree of variation of the characteristic of the backlight sensor 9 against the reference value and correcting the output of the ambient light sensor 10 on the basis of the detected correction value, it is possible to improve the detecting accuracy of the ambient light sensor 10.

In turn, the description will be oriented to the control for the light modulation. As shown in FIG. 5, based on the corrected output 14, the next light modulation setting data to be shifted according to the ambient light is read out of the light modulation table 61. Then, the light modulation setting data control circuit 62 selects the light modulation data read out of the light modulation table 61 or the new light modulation data not to be shifted with reference to the relation between the currently set light modulation data held in the holding circuit 64 and the new light modulation data and then generates the light modulation setting data 11.

For example, as shown in FIG. 6, the backlight modulation control is grouped into three levels of B1, B2 and B3 and the received light illuminances of the ambient light sensor corresponding with these levels are denoted as E1, E2, E3 and E4 respectively. In this illustration, a hysteresis given in the shift from a low luminance to a high one or vice versa results in being able to reduce the display flickering caused by the light modulation control.

The backlight modulation signal converter circuit 63 converts the light modulating setting data 11 into the light modulation control signal 16 being suited to the backlight module drive circuit 17 shown in FIG. 1. For example, the light modulation signal 16 is a pulse-width-controlled signal or a voltage-modulated signal. As such, the backlight module drive circuit 17 is supplied with the light modulation signal 16, controls the backlight module 8 in response to the backlight drive signal 18, and controls the backlight modulation so that the backlight luminance may correspond with the ambient light.

As set forth above, according to this embodiment, for each panel, the correction value is detected by the backlight sensor with reference to the backlight luminance reference value. By correcting the output of the ambient light sensor on the detected correction value, the detecting accuracy of the ambient light sensor is more improved.

### Second Embodiment

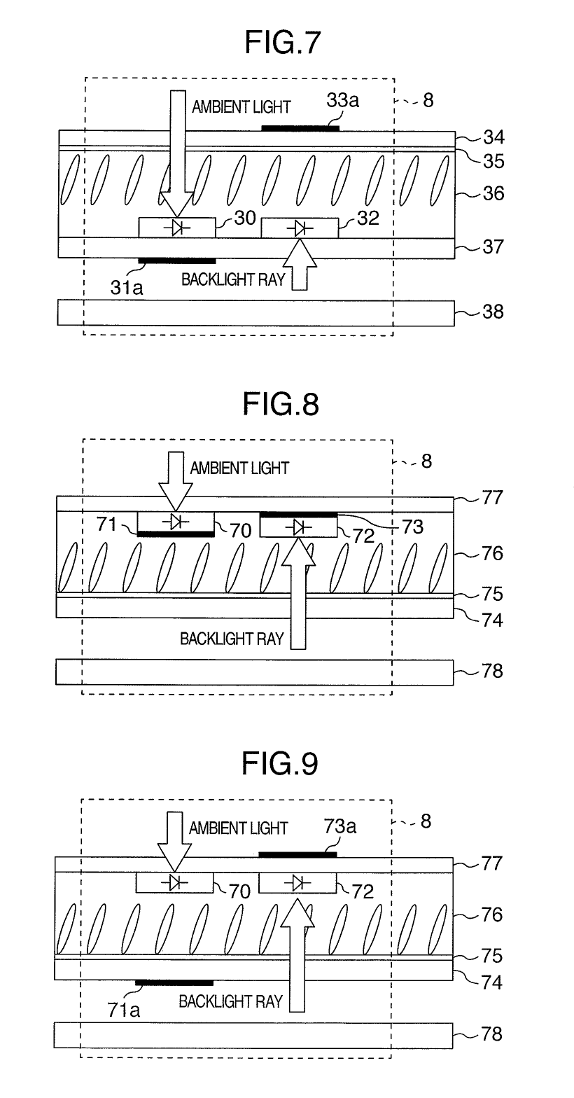

The second embodiment of the present invention will be described with reference to FIG. 7. The display operation of the liquid crystal display device and the light modulation control to be executed through the light sensors are the same as those described with respect to the first embodiment. The sectional structure of the light sensor pair 8 of the second embodiment is different from that shown in FIG. 2.

FIG. 7 shows a partial sectional structure of the light sensor pair 8. The difference of the structure shown in FIG. 7 from that of the first embodiment shown in FIG. 1 is a backlight shading film 31a and an ambient light shading film 33a. The film 31a is located outside of the lower glass substrate 37 and the film 33a is located outside of the upper glass substrate 34. The location of these light shading films outside of the glass substrates makes it possible to reduce the manufacturing cost of the liquid crystal panel.

### Third Embodiment

The third embodiment of the present invention will be described with reference to FIG. 8. The display operation of the liquid crystal display device and the light modulation to be executed through the light sensors are the same as those described with respect to the first embodiment. The difference between the third embodiment and the first embodiment is location of the light sensor pair 8 shown in FIG. 2.

FIG. 8 shows a partial sectional structure of the light sensor pair 8 including an ambient light sensor 70, a backlight shading film 71, a backlight sensor 72, an ambient light shading film 73, an upper glass substrate 77, a color filter 75, a liquid crystal layer 76, a lower glass substrate 74, and a backlight unit 78. The difference of this structure shown in FIG. 8 from that of the first embodiment shown in FIG. 2 is a TFT element formed on the side of the upper glass substrate 77.

Since the ambient light sensor 70 is located on the upper glass substrate 77, as compared with the ambient light sensor located on the lower glass substrate as shown in FIG. 2 with respect to the first embodiment, the quantity of the received ambient light may be enlarged without having to reduce the light quantity received by the ambient light sensor by virtue of a light transmittance of the liquid crystal layer through which light passes.

As the structure of the TFT element formed on the upper glass substrate 77, a top gate structure or a bottom gate structure may be used. In the bottom gate structure, the gate lines are formed on the side of the upper glass substrate 77 on which the TFT elements are formed, while in the top gate structure, no gate line is formed on the side of the upper glass substrate 77 on which the TFT elements are formed. Hence, the ambient light quantity to be shaded by the gate lines is reduced in the top gate structure, so that the quantity of light received from the outside of the upper glass substrate 77 in the top gate structure is greater than the quantity of light received therefrom in the bottom gate structure. It means that the top gate structure improves a sensitivity of the ambient light sensor.

As described above, in the case of forming the TFT elements on the side of the upper glass substrate 77, whichever of the top gate structure or the bottom gate structure the TFT elements may take, as compared with the case in which the TFT elements are formed on the side of the lower glass substrate as shown in FIG. 2 and described with respect to the first embodiment, a detecting sensitivity of the ambient light sensor may be improved more.

### Fourth Embodiment

The fourth embodiment of the present invention will be described with reference to FIG. 9. The display operation of the liquid crystal display device and the light modulation to be executed through the light sensors are the same as those described with respect to the first embodiment. The difference is the sectional structure of the light sensor pair 8 shown in FIG. 8 and described with respect to the third embodiment.

FIG. 9 shows a partial sectional structure of the light sensor pair 8. The difference of the partial sectional structure from that shown in FIG. 8 with respect to the third embodiment is a backlight shading film 71a and an ambient light shading film 73a. The film 71a is formed outside of the lower glass substrate 74 and the film 73a is formed outside of the upper glass substrate 77. This location of these shading films outside of the glass substrates makes it possible to reduce the manufacturing cost of the liquid crystal panel.

### Fifth Embodiment

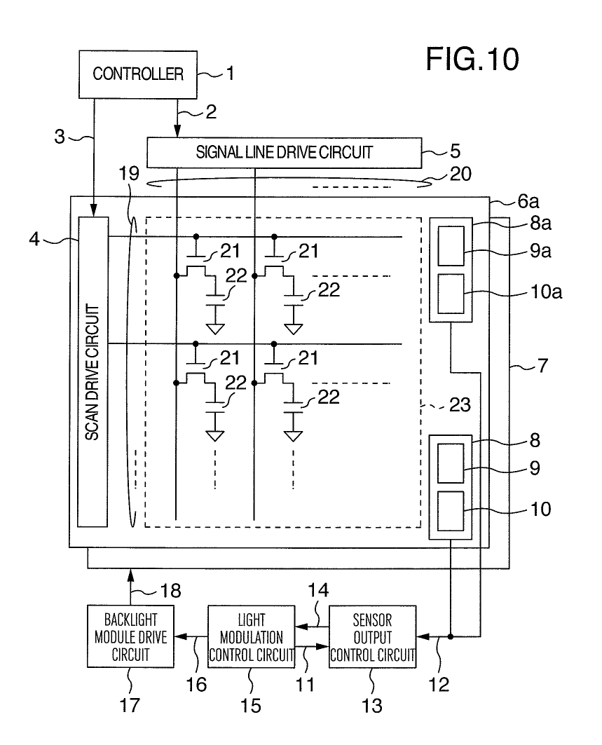

The fifth embodiment of this invention will be described with reference to FIG. 10. The display operation of the liquid crystal display device and the light modulation to be executed through the light sensors are the same as those described with respect to the first embodiment. The difference of this embodiment from the first embodiment is formation of the light sensor pair at two spots around the pixel portion 23.

FIG. 10 is a block diagram showing a liquid crystal display device according to the fifth embodiment of the invention. Two light sensor pairs 8 and 8a are mounted on the liquid crystal panel 6a. The other components and their disposition are the same as those described and shown with respect to the first embodiment.

In this embodiment, the outputs of the ambient light sensors 10a and 10a and the outputs of the backlight sensors 9 and 9a are applied into a sensor output control circuit 13. Since the two light sensor pairs 8 and 8a are used for the detection, the illuminance distribution variation on the liquid crystal panel 6a and the characteristic variation of each output area averaged by the outputs of the two light sensor pairs 8 and 8a. This makes it possible to improve the accuracy of the output. Moreover, in this embodiment, the number of the light sensor pairs is two. However, the number is not limited to two. For example, the light sensor pairs may be at the four corners of the liquid crystal panel 6a.

### Sixth Embodiment

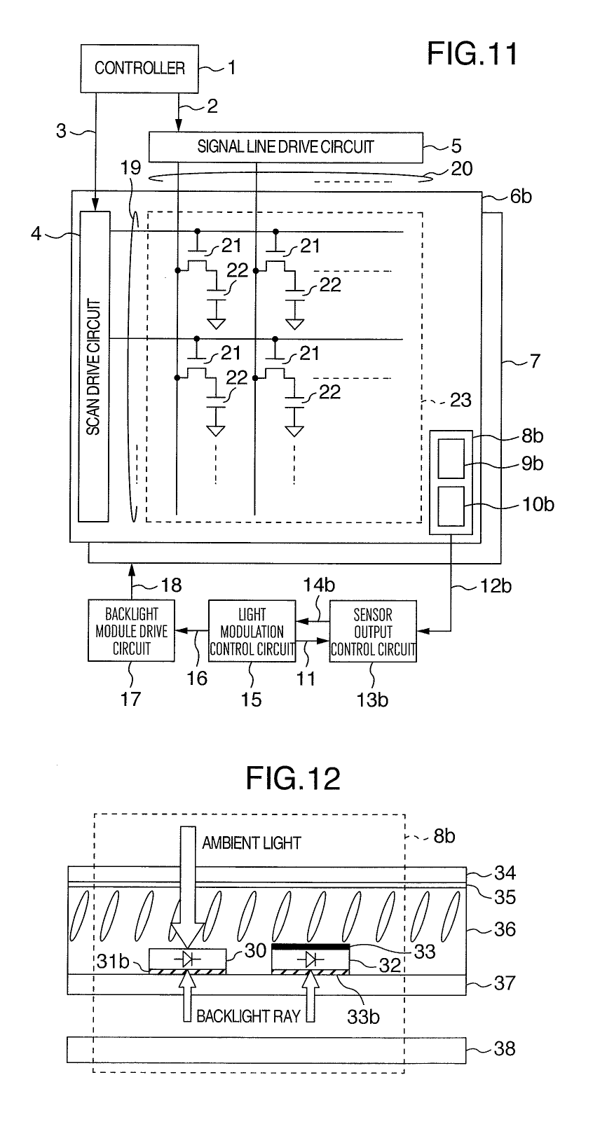

The sixth embodiment of the present invention will be described with reference to FIGS. 11 to 14. The display operation of the liquid crystal display device according to this embodiment is the same as that of the first embodiment. The difference of this embodiment from the first embodiment is that the backlight is not completely cut off in the light modulation to be executed through the use of the ambient light sensor, for improving a sensitivity of a low luminance area.

FIG. 11 is a block diagram showing a liquid crystal display device according to the sixth embodiment of the invention including a liquid crystal panel 6b, a light sensor pair 8b formed on the liquid crystal panel 6b, a backlight sensor 9b and an ambient light sensor 10b composing the light sensor pair 8b, and a sensor output control circuit 13b. A numeral 12b denotes an output of the light sensor. A numeral 14b denotes a corrected output. The other components and their disposition are the same as those shown in FIG. 1 and described with respect to the first embodiment.

FIG. 12 shows a partial section of the light sensor pair 8b. In FIG. 12, a semi-transparent light shading means (film) 31b serves to semi-transparently pass a ray of backlight to be applied into the ambient light sensor 30. A semi-transparent light shading means (film) 33b serves to semi-transparently pass a ray of backlight to be applied into the backlight sensor 32. The other components and their disposition of this embodiment are the same as those shown in FIG. 2 and described with respect to the first embodiment.

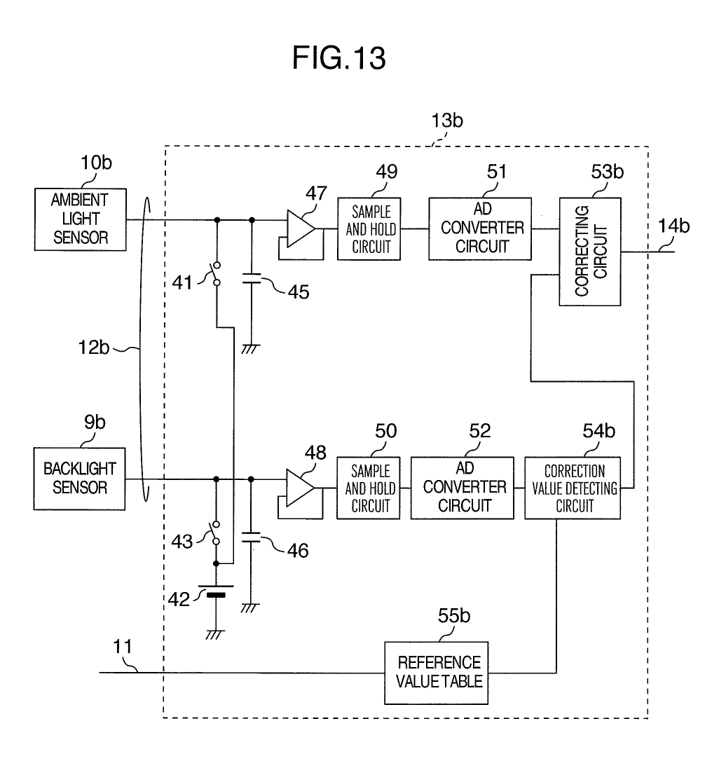

FIG. 13 is a block diagram showing the sensor output control circuit 13b. The control circuit 13b includes a correction value detecting circuit for detecting a correction value of the backlight sensor 9b, a reference value table 55b, and a correcting circuit 53b for correcting an output of the ambient light sensor 10b with the correction value sent from the circuit 54b and outputting the corrected output. The other components and their disposition are the same as those shown in FIG. 3 and described with respect to the first embodiment.

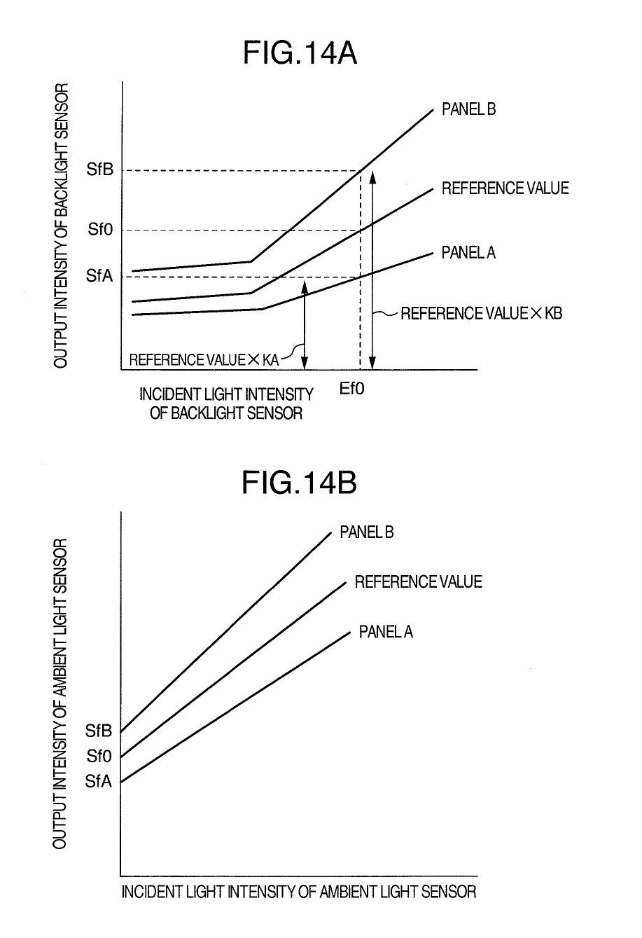

FIG. 14A shows relation between an incident light intensity and an output intensity of the backlight sensor 9b. FIG. 14B shows relation between an incident light intensity and an output intensity of the ambient light sensor 10b.

The display device of this embodiment is operated similarly to the display device of the first embodiment. Hence, the description will be oriented to the light modulation. The light sensor pair 8b located on the liquid crystal panel 6b, as shown in FIG. 11, is made up of the ambient light sensor 30 composed of a photoelectric converting thin film transistor and the backlight sensor 32 composed of the same type of transistor, both of these sensors 30 being formed adjacently to each other and on the side of the lower glass substrate 37 on which the TFT elements are formed as shown in FIG. 12.

Also as shown in FIG. 12, the ambient light sensor 30 senses a light quantity of the ambient light received from the display side and the backlight side does not completely shade the backlight but passes 20% of backlight through the semi-transparent light shading film 31b. The backlight sensor 32 senses a quantity of backlight passed through the semi-transparent light shading film 33b and received from the lower side and the display side shades light through the ambient light shading film 33 so that no influence by the ambient light may be given to the sensor 32. The backlight transmittances of the semi-transparent light shading films 31b and 3b are set to the same value of 20%, for example.

As described above, the ambient light sensor 30 senses a light quantity totaling an ambient light quantity and a quantity of backlight passed through the semi-transparent light shading film 31b. At a time, the backlight sensor 32 senses the backlight passed through the semi-transparent light shading film 33b.

The light sensor output 12b sent from the light sensor pair 8b shown in FIG. 11 is inputted into the sensor output control circuit 13b shown in FIG. 13. In FIG. 13, the output of the ambient light sensor 10b is connected with the sensor output capacitance 45 and with the precharge power supply 42 through the precharge switch 41. Further, the output of the backlight sensor 9b is connected with the sensor output capacitance 46 and with the precharge power supply 42 through the precharge switch 43. In the subsequent stage, the buffer circuits 47, 48, the sample and hold circuits 49, 50, and the AD converter circuit 51, 52 are operated similarly with those shown in FIG. 3 and described with respect to the first embodiment.

In turn, the description will be oriented to the operation of the correction value detecting circuit 54b, the reference value table 55b and the correcting circuit 53b.

The correction value detecting circuit 54b calculates a degree of variation o the output intensity of the backlight sensor 9b relative to the reference value on the basis of the relation between the incident light intensity and the output intensity of the backlight sensor 9b shown in FIG. 14A.

The current light modulation is carried out by referring to the light modulation setting data 11. The reference value corresponding with this light modulation setting data 11 is read out of the reference value table 55b. The backlight luminance reference value corresponding therewith is let to be Ef0 and the reference output value of the backlight sensor 9 corresponding therewith is let to be Sf0 as shown in FIG. 14.

For the panel A shown in FIG. 14A, for example, letting SfA be the output of the backlight sensor 9b with respect to the backlight luminance reference value Ef0, the output of the backlight sensor 9b provided in the panel A is variable by a coefficient KA relative to the reference value. Turning to the panel B, letting SfB be the output of the backlight sensor 9b relative to the backlight luminance reference value Ef0, the output of the backlight sensor 9b provided in the panel B is variable by a coefficient KB relative to the reference value. As described above, the correction value detecting circuit 54b detects the characteristic of the backlight sensor 9b for each liquid crystal panel based on the backlight luminance reference value Ef0.

Then, the correcting circuit 53b corrects the output of the ambient light sensor 10b based on the sensed output of the backlight sensor 9b located in the correction value detecting circuit 54b and then outputs the result as the corrected output 14b. Herein, since the ambient light sensor 10b receives the quantity of backlight passed through the semi-transparent light shading film 31b, as shown in FIG. 14B, even if the incident ambient light intensity is zero (0), the ambient light sensor 10b obtains as its output intensity SfA for the panel A, SfB for the panel B, and Sf0 for the reference value. It means that if the ambient light sensor 10b is inferior in detecting sensitivity on a low luminance area, since the ambient light sensor 10b receives the part of backlight passed through the semi-transparent light shading film 31b, the ambient light sensor 10b may have the improved detecting sensitivity even in the low luminance environment.

For the panel A shown in FIG. 14B, for example, with respect to the incident light intensity of the ambient light sensor 10b, the output intensity of the ambient light sensor 10b is KA times more variable than the reference value, so that the sensed output of the sensor 10b is KA times more shifted if it is used as it is. To overcome this shift, the correcting circuit 53b corrects the output of the ambient light sensor 10b by a factor of 1/KA, for obtaining a more accurate corrected output 14b. Turning to the panel B, likewise, with respect to the incident light intensity, the output intensity of the ambient light sensor 10b is KB times more variable than the reference value, so that the sensed output of the sensor 10b is KB times more shifted if it is used as it is. Hence, the correcting circuit 53b corrects the output of the sensor 10b by a factor of 1/KB, for obtaining a more accurate corrected output 14b.

As described above, the location of the backlight sensor 9b and the ambient light sensor 10b adjacently to each other makes it possible to keep the manufacturing variations such as the process variation even in these two light sensors. Hence, about a degree of variation of the characteristic of the backlight sensor 9b as compared with the reference value, the correction value is detected for each panel. If the sensitivity is inferior in a low luminance area, since the ambient light sensor 10b receives a part of backlight passed through the semi-transparent light shading film 31b, the ambient light sensor 10b keeps its sensitivity high. As described above, by correcting the output of the ambient light sensor 10b, it is possible to improve the detecting accuracy of the ambient light sensor 10b.

The later control for light modulation is likewise to that shown in FIGS. 5 and 6 and described with respect to the first embodiment and thus is not described herein. As set forth above, in this embodiment, even in the low luminance environment, the light modulation of the liquid crystal display device can be carried out with high accuracy.

### Seventh Embodiment

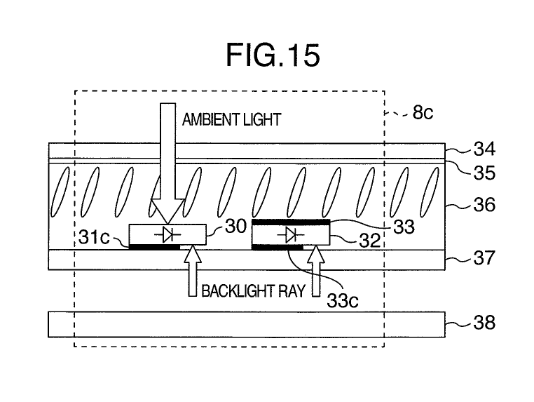

The seventh embodiment of the present invention will be described with reference to FIG. 15. The display operation of the liquid crystal display device and the light modulation to be executed through the ambient light sensor are the same as those described with respect to the sixth embodiment. However, the semi-transparent light shading means (film) formed on part of the light sensor pair is different therefrom.

FIG. 15 shows a partial structure of a light sensor pair 8c including a semi-transparent light shading film 31c of the ambient light sensor 30 and a semi-transparent light shading film 33c of the backlight sensor 32. The other components and their disposition are the same as those of the sixth embodiment.

In FIG. 15, the semi-transparent light shading films 31c and 33c do not completely cover the ambient light sensor 30 and the backlight sensor 32 but pass 20% of backlight therethrough. Like the sixth embodiment, if the ambient luminance is low, the light modulation of the liquid crystal display device can be carried out more accurately according to the ambient light.

It should be further understood by those skilled in the art that although the foregoing description has been made on embodiments of the invention, the invention is not limited thereto and various changes and modifications may be made without departing from the spirit of the invention and the scope of the appended claims.

1. A display device comprising:
a display panel having an ambient light sensing circuit for sensing ambient light and a backlight sensing circuit for sensing a ray of backlight located adjacent to each other and on part of a peripheral portion of a pixel module on which pixels are located in matrix;
a reference value table for saving reference values corresponding with the rays of backlight;
a detecting circuit for comparing an output value of the backlight sensing circuit with the reference value read from the reference value table, for detecting a correction value;
a correcting circuit for correcting an output from the ambient light sensing circuit based on the correction value; and
a control circuit for controlling the ray of backlight according to the output from the correcting circuit.

2. The display device as claimed in claim 1, wherein the ambient light sensing circuit is shaded from the ray of backlight by a backlight shading member and the backlight sensing circuit is shaded from the ambient light by an ambient light shading member.

3. The display device as claimed in claim 2, wherein the display panel is made up of an upper glass substrate located on the side of a display surface and a lower glass substrate located on the side of a backlight surface and,
the backlight shading member and the ambient light shading member are formed between the upper glass substrate and the lower glass substrate.

4. The display device as claimed in claim 2, wherein the display panel is made up of an upper glass substrate located on the side of a display surface and a lower glass substrate located on the side of a backlight surface and,
the backlight shading member is formed on the outside of the lower glass substrate and the ambient light shading member is formed on the outside of the upper glass substrate.

5. The display device as claimed in claim 3, wherein the ambient light sensing circuit and the backlight sensing circuit are formed of thin film transistors on the lower glass substrate.

6. The display device as claimed in claim 3, wherein the ambient light sensing circuit and the backlight sensing circuit are formed of thin film transistors on the upper glass substrate.

7. The display device as claimed in claim 1, wherein the ambient light sensing circuit and the backlight sensing circuit are shaded by semi-transparent shading members each of which has the same light transmittance.

8. The display device as claimed in claim 1, further comprising:
a sensor output control circuit for detecting a degree of variation of the output from the backlight sensing circuit relative to the reference value and correcting the output from the ambient light sensing circuit based on the detected result;
an output circuit for outputting a control signal based on the corrected output from the sensor output control circuit; and
a backlight module drive circuit for modulating a ray of backlight based on the control signal.

9. The display device as claimed in claim 1, wherein the correction value is a value to be used for canceling a variation of the ray of backlight relative to the reference value.

10. The display device as claimed in claim 1, wherein the correction circuit operates to integrate a reverse number of the correction value into the output from the ambient light sensing circuit.
